(19) United States
(12) Patent Application Publication
(10) Pub. No.: US 2023/0136200 A1
(43) Pub. Date: May 4, 2023

(54) Organization-based Template Publishing and Discovery

(71) Applicant: Microsoft Technology Licensing, LLC, Redmond, WA (US)

(72) Inventors: Shane Michael CHISM, Bellevue, WA (US); Ronald Oswin PESSNER, JR., Redmond, WA (US); Nathan Darrel KILE, JR., Mercer Island, WA (US); Paul Anthony SCUDIERI, Westerville, OH (US); Daniel Gabriel ZARZAR, Redmond, WA (US)

(73) Assignee: Microsoft Technology Licensing, LLC, Redmond, WA (US)

(21) Appl. No.: 17/685,245

(22) Filed: Mar. 2, 2022

Related U.S. Application Data
(60) Provisional application No. 63/274,267, filed on Nov. 1, 2021.

(51) Int. Cl. G06Q 10/10; G06F 40/186; G06F 3/14

(52) U.S. Cl. CPC G06Q 10/10; G06F 3/14; G06F 40/186

(57) ABSTRACT

A data processing system implements receiving, from a first user, a first request to submit a first template for an electronic document to a template publication service, the request includes first policy information indicating who may access the template and is available only to users who are associated with a first organization; storing the first template and the first policy information in a template data store; receiving, from a second user, a second request for available templates from the template data store; determining that the second user has access to the first template based on the policy information and the information identifying the second user indicating that the second user is associated with the first organization; including the first template in a plurality of first templates determined to be available to the second user; and causing the plurality of first templates available to the second user to be displayed.

### CROSS-REFERENCE TO RELATED APPLICATIONS

This application claims the benefit of priority from pending U.S. Provisional Pat. Application Serial No. 63/274,267, filed on Nov. 1, 2021, and entitled “Organization-Based Template Publishing and Discovery.”

### BACKGROUND

Templates are commonly used in word processing applications, presentation applications, project management software, web pages and/or web applications, and other types of applications to facilitate content creation. Templates often provide a sample format or layout for an electronic document or other electronic content. The templates may also include some textual, image, video, audio, and/or other content that provides a starting point for a user to create a new electronic document or other electronic content. The content provided may be modified and/or added to by the user when creating the new electronic document or electronic content. Templates may significantly speed up the process of authoring an electronic document and may also provide a common look and feel to documents used by a company or other organization, a division of a company or other organization, a business group, or other discrete part of a company or other organization. Templates may be provided with certain software applications or may be available through online template providers. The online template providers may permit users to upload templates that may be downloaded and utilized by other users. The templates provided by both sources are often unsuitable for use within an organization, as each organization or discrete part of the organization typically has very specific needs that are not met by the templates available from these template sources. The templates provided with applications are often very general so that they may be utilized by a very diverse user base of the applications. Similarly, many of the templates that that may be provided by online template providers may be created by other users who have very different needs, and templates that may potentially be useful may be difficult to locate in the vast quantity of templates offered by the template providers. Hence, there is a need for improved systems and methods for publishing and discovering templates for use in an organization.

### SUMMARY

An example data processing system according to the disclosure may include a processor and a machine-readable medium storing executable instructions. The instructions when executed cause the processor to perform operations including receiving, from a first computing device associated with a first user, a first request to submit a first template for an electronic document to a template publication service, wherein the request includes first policy information indicating who may access the template, the first policy information indicating that the first template is available only to users who are associated with a first organization; storing the first template and the first policy information in a template data store; receiving, from a second computing device associated with a second user, a second request for available templates from the template data store, the second request including information identifying the second user; determining that the second user has access to the first template based on the policy information and the information identifying the second user indicating that the second user is associated with the first organization; including the first template in a plurality of first templates determined to be available to the second user; and causing to be displayed on a display of the second computing device a user interface presenting the plurality of first templates determined to be available to the second user.

An example method implemented in a data processing system for operating a template publication service includes receiving, from a first computing device of a first user, a first request to submit a first template for an electronic document to the template publication service, wherein the request includes first policy information indicating who may access the template, the first policy information indicating that the first template is available only to users who are associated with a first organization; storing the first template and the first policy information in a template data store; receiving, from a second computing device of a second user, a second request for available templates from the template data store, the second request including information identifying the second user; determining that the second user has access to the first template based on the policy information and the information identifying the second user indicating that the second user is associated with the first organization; including the first template in a plurality of first templates determined to be available to the second user; and causing to be displayed on a display of the second computing device a user interface presenting the plurality of first templates determined to be available to the second user.

An example machine-readable medium on which are stored instructions. The instructions when executed cause a processor of a programmable device to perform operations of receiving, from a first computing device of a first user, a first request to submit a first template for an electronic document to a template publication service, wherein the request includes first policy information indicating who may access the template, the first policy information indicating that the first template is available only to users who are associated with a first organization; storing the first template and the first policy information in a template data store; receiving, from a second computing device of a second user, a second request for available templates from the template data store, the second request including information identifying the second user; determining that the second user has access to the first template based on the policy information and the information identifying the second user indicating that the second user is associated with the first organization; including the first template in a plurality of first templates determined to be available to the second user; and causing to be displayed on a display of the second computing device a user interface presenting the plurality of first templates determined to be available to the second user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein for an organization-based template publishing and discovery may be implemented.

FIG. 2 is a diagram showing additional details of the template publication service shown in FIG. 1.

FIG. 3 is a diagram showing additional details of the template recommendation unit of the template publication service shown in FIGS. 1 and 2.

FIG. 4 is a diagram showing an example graphical user interface for presenting a template gallery.

FIG. 5 is a diagram showing an example graphical user interface for adding a new template to the template gallery shown in FIG. 4.

FIG. 6 is a flow chart of an example process for hosting an online presentation.

FIG. 7 is a block diagram showing an example software architecture, various portions of which may be used in conjunction with various hardware architectures herein described, which may implement any of the described features

FIG. 8 is a block diagram showing components of an example machine configured to read instructions from a machine-readable medium and perform any of the features described herein.

FIG. 9 is an example of a template usage report user interface provided by the template publication service.

FIG. 10 is an example of a template rating user interface provided by the template publication service.

FIG. 11 is an example of a template rating report user interface provided by the template publication service.

FIG. 12 is an example of a template report user interface provided by the template publication service.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques for publishing and discovering templates for use in an organization are described. These techniques provide a technical solution for locating templates that are appropriate for use by the organization or a discrete part of the organization. An organization-specific template publication service is provided to enables users associated with an organization or a discrete part thereof to create and publish templates that may be utilized by other users within the organization. The template publication service is configured to provide template recommendations for users that may be customized for the user. The template recommendations may be personal recommendations for the user based on the types of files typically created or used by the user, the types of content typically created or used by the user, the team, division, business group, or other discrete part of an organization to which the user belongs. The template recommendations may be role-based recommendations for templates that are created by or typically used by other users within the organization that have a similar role as the user within the organization. The role-based recommendations may also be associated with tasks that are commonly performed by users who have a similar role as the user within the organization. The recommendations may be generated by machine learning models trained to predict which templates available in a template data store of the template publication service may be relevant to a particular user. A technical benefit of this approach is that it makes more efficient use of computing resources by reducing the computing resources consumed by users searching for and accessing relevant templates.

The template publication service also provides means for enforcing security and compliance on templates published with the publication service. The templates provided with applications or through current template providers do not provide means for enforcing security and compliance. The template publication service provides means for controlling who may access the template through usage policies. The policy may limit the template to users within the organization or to users within a discrete part of the organization. The policy may be enforced at the time that a user attempts to access the template and to prevent unauthorized users from accessing the template. A technical benefit of this approach is that the sensitive information associated with the organization, or the discrete part of the organization, may not be inadvertently or intentionally disclosed outside of the group of users who are permitted to access the templates.

The template publication service also provides means for encouraging template reuse within an organization. The template publication service may provide means for users of the templates to provide feedback on the utility of the templates that those users have used. The template publication service may also provide means for estimating how much time and/or costs the usage of a particular template saves an organization. The template publication service may estimate this cost by estimating how long it would take a user to create a particular document similar to that produced without the template. A technical benefit of this approach is that reusing templates can save a significant amount computing storage by reducing the number of templates that may be used by an organization and the computing resource required for maintaining the template data store. These and other technical benefits of the techniques disclosed herein will be evident from the discussion of the example implementations that follow.

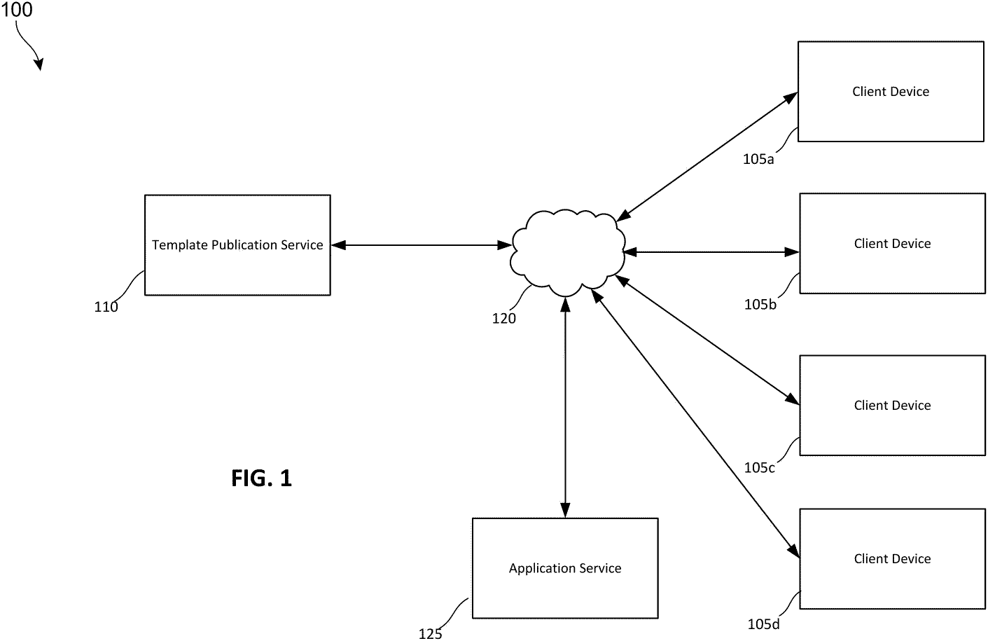

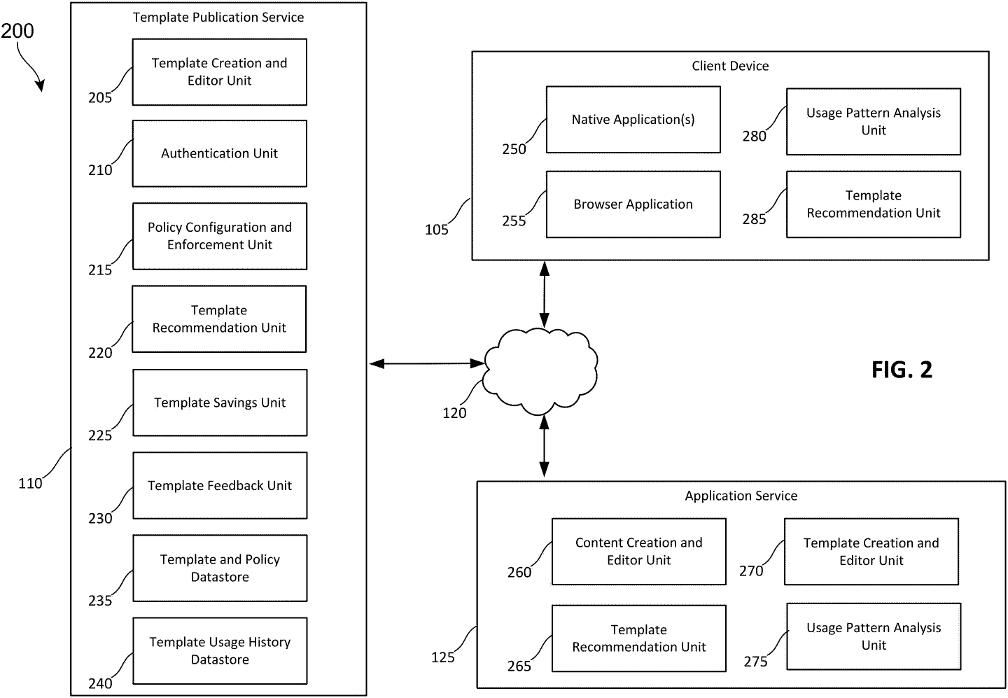

FIG. 1 is a diagram showing an example computing environment 100 in which the techniques disclosed herein for publishing and discovering templates for use in an organization may be implemented. The computing environment 100 may include a template publication service 110 and an application service 125. The example computing environment may also include a plurality of client devices, such as client devices 105a, 105b, 105c, and 105d. The client devices 105a, 105b, 105c, and 105d, the application service 125, and the template publication service 110 may communicate via the network 120. Additional details of the template publication service 110, the application service 125, and client devices 105a, 105b, 105c, and 105d are discussed in greater detail with respect to FIG. 2.

The template publication service 110 may be implemented as a cloud-based service or set of services. The template publication service 110 may be configured to provide a user interface that enables users to create new templates and/or publish new templates. The template publication service 110 may also be configured to impose security and compliance on templates published with the template publication service 110 through policies associated with the templates. The policies may be defined by individual users and/or by an organization or discrete part thereof for determining who may access a particular template. The template publication service 110 may also be configured to provide machine-learning driven recommendations for templates that are predicted to be relevant to the user. The template publication service 110 may also provide means for encouraging template publication and reuse. Additional details of these features are described with respect to FIG. 2.

The application service 125 may provide one or more cloud-based or network-based services for the computing devices 105a-105d. The application service 125 may provide a word processing application, a presentation application, project management software, a communications platform, a collaboration platform, a content sharing platform, a content creation platform, and/or other services that are accessible to users via the computing devices 105a-105d and allow the users to communicate and/or consume, create, share, collaborate on, and/or modify content. Other types of services may be provided by the application service 125 in addition to or instead of these services. The services provided by the application service 125 may be accessed via a native application on a computing device, via a native application configured to communicate with the application service 125, via other means, or via a combination thereof.

The application service 125 may be configured to allow users of the client devices 105a-105d to obtain templates from the template publication service 110 for creating new content and/or to publish templates to the template publication service 110 to facilitate content creation by other users. The template publication service 110 and the application service 125 may be configured to apply user-specified and/or organization-specified policy constraints on the usage and publication of templates. The user may specify that a particular template may only be utilized by users within the organization or within a discrete part of the organization. The user may also specify certain users may access the template. The template is not presented to users who are not permitted to access the template in search results or when browsing through the gallery. Furthermore, the templates may prevent unauthorized users from using the template. When a template is opened by an application, the policy associated with the template may be verified with the template publication service 110 to determine whether the user attempting to open the application is authorized to do so. Unauthorized users would be precluded from accessing the template. Thus, templates that contain sensitive information may not be inadvertently or intentionally leaked to unauthorized users by users authorized to access the template.

The client devices 105a, 105b, 105c, and 105d are computing devices that may be implemented as a portable electronic device, such as a mobile phone, a tablet computer, a laptop computer, a portable digital assistant device, a portable game console, and/or other such devices. The client devices 105a-105d may also be implemented in computing devices having other form factors, such as a vehicle onboard computing system, a video game console, a desktop computer, and/or other types of computing devices. Each of the client devices 105a-105d may have different capabilities based on the hardware and/or software configuration of the respective client device. While the example implementation illustrated in FIG. 1 includes four client devices, other implementations may include a different number of client devices.

FIG. 2 is a diagram showing additional details of the presentation and communications platform and client devices of the computing environment shown in FIG. 1. The template publication service 110 may include a template creation and editor unit 205, an authentication unit 210, a policy configuration and enforcement unit 215, a template recommendation unit 220, a template savings unit 225, a template feedback unit 230, a template and policy datastore 230, and a template usage history datastore 240.

The template and policy datastore 230 provides persistent storage for storing templates and policy information associated with the templates. The template and policy datastore 230 may provide means for elements of the template publication service 110 to store new templates and policy information and/or to access existing templates and/or policy information associated with the existing templates. The template and policy datastore 230 may be configured to support queries that permit elements of the retrieve templates from the template and policy datastore 230.

The template usage history datastore 240 provides persistent storage for storing usage data associated with templates stored in the template and policy datastore 230. The template publication service 110 may collect telemetry data from the client devices 105a-105d and/or the application service 125. The telemetry data may identify a template that has been created, used, or modified and information about the user who has utilized the template. Similar data may be collected by the template creation and editor unit 205 for templates created, accessed, or modified by users. The template publication service 110 may provide means for users to opt out of the telemetry data collection but the template publication service 110 may not be able to provide template recommendations that are as accurate for users who have opted out of the telemetry data collection due to the lack of usage history information for those users.

The template creation and editor unit 205 provides a user interface that enables a user to create new templates, edit existing templates, and/or publish the templates that the user has created. In some implementations, template creation and editor unit 205 may be configured to launch an application associated with the template to permit the user to create a new template or edit an existing template. In other implementations, the template creation and editor unit 205 may include logic for creating templates for one or more applications, such as but not limited to those provided by the application service 125.

The authentication unit 210 may provide means for verifying whether users are permitted to access the template publication service 110. The authentication unit 210 may provide means for receiving authentication credentials for the users from their respective client devices 105 or via the application service 125. The authentication unit 210 may be configured verify that the authentication credentials are valid and permit the user to access the services provided by the template publication service 110.

The policy configuration and enforcement unit 215 may be used to control who may view, access, create, and/or modify templates for the template publication service 110. The policy configuration and enforcement unit 215 may be used to publish a template to a scoped part of an organization. For example, the Human Resources department of the organization may publish certain templates that are intended for use by employees within that department. The Human Resources department may also publish other templates which may be accessible by others within the organization. For example, the Human Resources department may publish an employee review form that is accessible to managers throughout the organization. These examples demonstrate how access to the published templates may be limited to discrete groups of users both within and/or without the organization.

The policy configuration and enforcement unit 215 is configured to determine which templates a user may access and the actions that the user may perform on the template publication service 110. Unlike current template sources, which do not provide means for providing access control for templates, the policy configuration and enforcement unit 215 provides means for associating each template with a policy that indicates who may access the template and which actions that the user may perform on the template. For example, the policy may limit the template to users within a particular organization or to users within a discrete part of that organization. This approach ensures that even if a template is disseminated to a user that is not authorized to access the template, the policy configuration and enforcement unit 215 may prevent an unauthorized user from accessing the template or performing other actions on a template which are not authorized by the policy. For example, the policy associated with a template may permit certain users to modify the template and prohibit other users other than those specified from modifying the template maintained by the template publication service 110. However, even if a user is permitted to access a template but is precluded from making modifications to the template itself, the user may generate an electronic document based on the template. The policy permissions pertain the template itself and not to the documents generated using the template. However, the documents generated using the templates may have additional policy controls imposed on the usage and dissemination of the documents by the authors of the documents and/or by an organization or discrete part of an organization for which the document was created.

The policy configuration and enforcement unit 215 may be configured to enforce the policy at the time that a user attempts to access or perform other actions on a template. For example, a user may access a template from an application on their respective client device 105. The template may send a request to the template publication service 110 requesting an indication of the actions that the user is permitted to perform with the template. If the template publication service 110 indicates that the user is not authorized to access template, the template cannot be loaded by the application and the application may present a notification that the user does not have permission to access the template. In some implementations, the user may be prompted to provide authorization credentials if the user has not yet been authenticated by the template publication service 110. The policy may be enforced at the time that a user attempts to access the template and to prevent unauthorized users from accessing the template. A technical benefit of authenticating the user at the time that the user accesses a template is that sensitive information associated with the organization may not be inadvertently or intentionally disclosed outside of the group of users who are permitted to access the template.

The policy configuration and enforcement unit 215 may be configured to communicate with an external policy service (not shown) that is implemented separately from the template publication service 110. The external policy service may be configured to provide information rights management services for various types of electronic documents, including the templates accessed, created, edited, and/or published using the template publication service 110. The external policy service may be configured to associate policy information with a template file or other electronic document. When that document is opened in an application that is configured to view, edit, and/or create such documents, the application may send a request to the external policy service that includes information identifying the template or other document that the user is attempting to access and information identifying the user to the external policy service. The external policy service may provide an indication whether the user may access the template and/or perform other actions on the template in response to the request from the application.

In some implementations, the policy and configuration enforcement unit 215 may be implemented by the Microsoft 365 ® compliance center. The compliance center provides threat protection, data protection, and device management features for managing and protecting the data for organization. These protection and management features cover not only the data that may be stored on a cloud-based system, such as the template publication service 110 and/or the application service 125, but also to the client devices, such as the client devices 105a-105d, which may be used to access and/or modify the data. The compliance center may be used to configure who may view, access, create, and/or modify templates for the template publication service 110. The ability to view, access, create, and/or modify templates may be limited to users within an organization or a division, team, group or other subset of the organization.

The template publication service 110 may be configured to utilize such an external policy service for some or all the templates that may be accessible via the template publication service 110. The policy configuration and enforcement unit 215 may be configured to utilize an external policy service to manager some templates while the policy enforcement for other templates may be implemented by the policy configuration and enforcement unit 215. In particular, the policy configuration and enforcement unit 215 may be configured to determine whether a particular user may view, access, publish, and/or modify a template.

The policy configuration and enforcement unit 215 may be configured to serve as an external policy service for other applications. An external application implemented by an application service, such as the application service 125, or on a client device, such as the client device 105, may send a request to the template publication service 110 that includes information identifying the template that the user is attempting to access and information identifying the user to the template publication service 110. The policy configuration and enforcement unit 215 may provide an indication whether the user may access the template and/or perform other actions on the template in response to the request from the application.

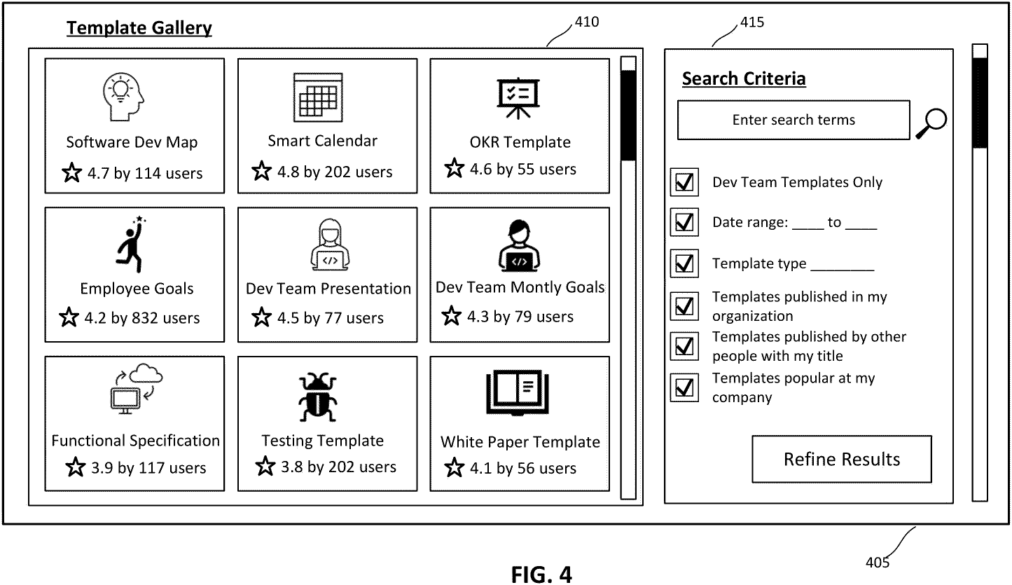

The template recommendation unit 220 is configured to provide template recommendations to a user. The template recommendation unit 220 may be configured to present the templates in a template gallery interface, such as that shown in FIG. 4. The template recommendation unit may be configured to identify templates that have been published to the template publication service 110 and are accessible by the user based on the policies associated with those templates. The recommended templates may be presented in the user as a series of thumbnail images or icons representing each of the recommended templates. The user may click on or otherwise activate a thumbnail image or icon representing a particular template in order to download the template to the respective client device 105 of the user and/or to open the template on the client device 105 of the user with a particular application associated with the template.

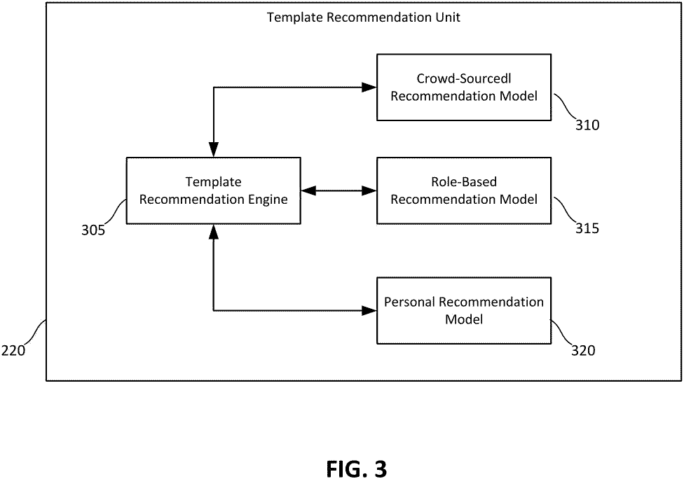

The template recommendation unit 220 may be configured to use one or more machine learning models to select the recommended templates that are presented to the user. Additional details of the machine learning models are presented in the example implementation of the template recommendation unit 220 shown in FIG. 3, which is discussed in detail in the examples which follow. The machine learning models may provide predictions of the types of templates that may be most useful to a user based on various factors discussed in greater detail with respect to FIG. 3. A technical benefit of this approach is that the models may help to significantly reduce the amount of time and computing resources required for a user to locate a potentially useful template in the set of templates maintained by the template publication service 110. The template publication service 110 may maintain many templates and some of those templates may not be applicable to the types of tasks that a particular user is likely to perform. The models shown in FIG. 3 are trained to provide recommendations to help users more efficiently utilize their time and the computing resources to find relevant templates.

The template savings unit 225 may be configured to determine an estimate of how much time and/or costs the usage of a particular template has saved an organization and/or a discrete part of the organization. The template savings unit 225 may be configured to estimate how long it would take a user to develop a particular content item without the use of a template. The template savings unit 225 may use a machine learning model trained to predict how long a particular content item would take an average user to prepare. The machine learning model may be trained using training data that provides example templates and an estimate of the amount of time that an average user would take to prepare those templates. The template savings unit 225 may provide a template to the machine learning model as an input, and the machine learning model may analyze the template and provide a prediction as to how long such a template may take the average user to prepare.

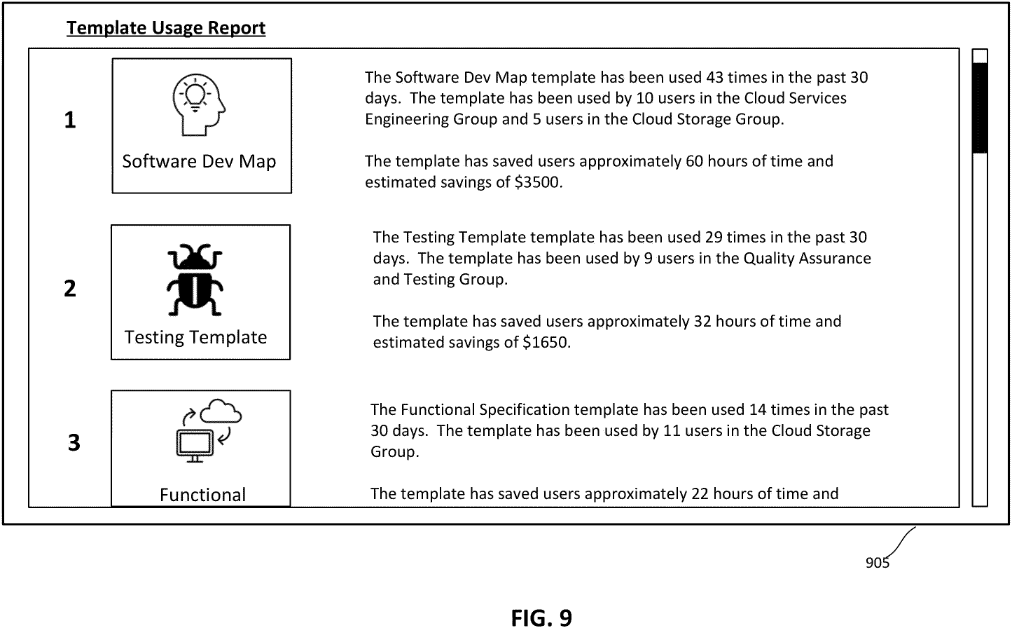

The template savings unit 225 may use the prediction provided by the machine learning model and information indicating how long the user spent developing the content item using the template to estimate how much time was saved by using the template. This time savings can also be translated into cost savings by estimating cost savings by using the template. For example, the template savings unit 225 may estimate that using the template saves the average user approximately two hours of an average salary of $35 per hour for an estimate cost savings of $70. This example demonstrates an example of one such way that the template savings unit 225 may estimate cost savings. As multiple users within an organization or a discrete part of the organization make use of the templates, the cost savings achieved may be significant. The template savings unit 225 may report these estimated savings to the authors of the template, a supervisor of the author of the template, and/or other individual within the organization. These reports may highlight savings that may be achieved by encouraging the reuse of templates within the organization. The savings achieved using a particular template may also be used to select templates to recommend to users. FIG. 9, which is discussed in detail in the examples which follow, provides an example of a template usage report that provides information about the templates that have been used and estimated savings in terms of time savings and monetary savings achieved through the usage of each template included in the report.

The template feedback unit 230 may be configured to provide means for identifying templates that have been most useful to other users. The template feedback unit 230 may provide a user interface that allows a user to rate one or more aspects of the usefulness of the template. The user interface may provide a means for providing a rating on the template on one or more categories of usefulness, such as but not limited to the overall usefulness of the template, the layout of the template, the content included in the template, and other aspects of the template. These ratings may be used to rank the available templates when presenting available templates to the user. This approach may also encourage template reuse by presenting templates that other users have found to be useful to the user.

The client device 105 may include one or more native applications 250, a browser application 255, and usage pattern analysis unit 280. The one or more native applications 250 may be an application developed for use on the client device 105. The one or more native applications 250 may be an application that may communicate with the application service 125 to enable users to consume, create, share, collaborate on, and/or modify content. The browser application 255 may be an application for accessing and viewing web-based content. The application service 125 may provide a web application that enables users to consume, create, share, collaborate on, and/or modify content. The presenter or the participants may access the web application and render a user interface for interacting with the application service 125 in the browser application 255. The application service and/or the template publication service 110 may support both the one or more native applications 250 and the web application, and user may choose which approach best suits their needs. The template publication service 110 may also provide support for the one or more native applications 250, the browser application 255, or both to provide a means for user of the client device 105 to browse available templates, select templates from the available templates for use in creating content, and to publish new templates.

The usage pattern analysis unit 280 may be configured to collect telemetry information indicative of the usage of applications, such as those provided by the application 125, by users of the client device 105. The usage pattern analysis unit 280 may be configured to analyze the telemetry data collected using one or more machine learning models to obtain predictions of the types of templates which may interest the user. These predictions can be used to provide template recommendations that are likely to be relevant to the user based on the types of applications that the user typically uses and/or the types of content items that the user typically accesses and/or creates.

The application service 125 may include a content creation and editor unit 260, a template recommendation unit 265, a template creation and editor unit 270, and a usage pattern analysis unit 275. The content creation and editor unit 260 provides means for a user to consume, create, share, collaborate on, and/or modify content. The content creation and editor unit 260 may provide a web-based user interface for accessing the services provide by the application service 125. The application service 125 may also be configured to provide means for the one or more native applications 250 on a client device 105 to access the services provided by the application service 125 using user interfaces provided by the one or more native applications 250.

The template recommendation unit 265 may operate similarly to the template recommendation unit 220 of the template publication service 110. The template recommendation unit 265 may implement one or more machine learning models configured to predict which templates available to a user may be most useful.

The template creation and editor unit 270 may be similarly to the template creation and editor unit 205 of the template publication service 110. The template creation and editor unit 270 may provide a user interface that enables a user to create new templates, edit existing templates, and publish the templates that the user has created to the template publication service 110. In some implementations, template creation and editor unit 205 may be configured to launch an application associated with the template to permit the user to create a new template or edit an existing template. In other implementations, the template creation and editor unit 205 may include logic for creating templates for one or more applications, such as but not limited to those provided by the application service 125.

The usage pattern analysis unit 275 may be configured to collect and analyze usage information indicative of usages of the one or more applications provided by the application service 125. The usage pattern analysis unit 275 may operate similar to the usage pattern analysis unit 280 of the client device 105 described above.

FIG. 3 is a diagram showing additional details of the template recommendation unit 220 of the template publication service shown in FIGS. 1 and 2. The template recommendation unit 220 may include a template recommendation engine 305, a crowd-sourced recommendation model 310, a role-based recommendation model 315, and a personal recommendation model 320. Other implementations may include a different number and/or types of recommendation models. The machine learning models utilized by the template recommendation unit 220 are trained to predict which templates available in a template data store of the template publication service 110 may be relevant to a particular user. A technical benefit of this approach is that it makes more efficient use of computing resources by reducing the computing resources consumed by users searching for and accessing relevant templates. These computing resources may instead be allocated to creating new templates and/or modifying new templates.

The template recommendation engine 305 may be configured to access template information for templates available to the template publication service 110. The templates may be stored in searchable persistent data store of the template publication service 110, such as the template and policy datastore 235. The template recommendation engine 305 may also be configured to obtain other information associated with the user for whom the template recommendation is to be provided, information indicating a role associated with the user and the types of tasks typically performed by users having that role, and/or information indicating the types of templates typically selected by other users. The template recommendation engine 305 may provide the available template information and the other types of information associated with the user, the user’s role, or other users as an input to the machine learning models.

The template recommendation engine 305 may also be configured to filter the template recommendations to present templates associated with a particular organization or a discrete part of that organization. One way that the template recommendation engine 305 may be configured to only provide templates that are associated with the organization or discrete part of that organization as inputs to the various machine learning models used by template recommendation engine 305. Alternatively, the template recommendation engine 305 may filter out templates that are not associated with the organization or discrete part of the organization associated with the user for whom the template recommendations are being provided.

The personal recommendation model 320 may be trained to predict templates that the user may be interested in based on the types of files typically created or used by the user, the types of content typically created or used by the user, the team, division, business group, or other discrete part of an organization to which the user belongs. The personal recommendation model 320 may obtain user information associated with the user for whom the recommendation is being provided, template usage information from the template usage history datastore 240, and/or other information as an input. The personal recommendation model 320 may provide a prediction of one or more attributes of the types of template that the user may be interested in and the template recommendation engine 305 may use this information to query the template and policy datastore 235 for templates which have those attributes.

The predictions made by the personal recommendation model 320 may be improved over time based on feedback received from the user in response to the recommendations provided. The feedback may be explicit or implicit. The template recommendation unit 220 may provide a user interface that enables the user to provide explicit feedback regarding template recommendations. The template recommendation unit 220 may also determine implicit feedback based on the templates that the user selects and uses to create content. Templates which are presented to the user but not selected may be rated lower than templates which have been selected and used by the user. The implicit and/or express feedback may be used to generate training data that may be used to adjust the inferences made by the personal recommendation model 320 to improve the recommendations provided by the model.

The role-based recommendation model 315 may be trained to provide template recommendations for templates created by and/or typically used by other users having a similar role as the user for whom the template recommendation is being provided, and/or for templates associated with tasks typically performed by users having a similar role within an organization. The role-based recommendation model 315 may obtain user information associated with the user for whom the recommendation is being provided, template usage information from the template usage history datastore 240, and/or other information as an input. The role-based recommendation model 315 may provide a prediction of one or more attributes of the types of template that the user may be interested in based on the user’s role and the template recommendation engine 305 may use this information to query the template and policy datastore 235 for templates which have those attributes. Express and/or implicit feedback from the users may be used to improve the recommendations provided by the role-based recommendation model 315. Express feedback may be obtained by the template feedback unit 230, and implicit feedback may be determined based on which templates that have been recommended by the role-based recommendation model 315 and have been used by users to whom these templates were recommended.

The crowd-sourced recommendation model 310 may be configured to predict templates that the user may be interested in based on the types of files typically created or used by many users, the types of content typically created or used by many users. The users may be within the same the team, division, business group, or other discrete part of an organization to which the user belongs or may be other users who are not withing the same organization. The crowd-sourced recommendation model 310 may provide a prediction of one or more attributes of the types of template that the user may be interested in based on the user’s role and the template recommendation engine 305 may use this information to query the template and policy datastore 235 for templates which have those attributes. Express and/or implicit feedback from the users may be used to improve the recommendations provided by the crowd-sourced recommendation model 310. Express feedback may be obtained by the template feedback unit 230, and implicit feedback may be determined based on which templates that have been recommended by crowd-sourced recommendation model 310 and have been used by users to whom these templates were recommended.

FIG. 4 is a diagram showing an example graphical user interface 405 for presenting a template gallery. The template gallery may include a set of template recommendations arranged in a gallery pane 410 as a set of thumbnail images or icons representing each of the recommended templates. The user may click on or otherwise activate a thumbnail image or icon representing a particular template in order to download the template to the respective client device 105 of the user and/or to open the template on the client device 105 of the user with a particular application associated with the template.

The user interface 405 may also include a search criteria pane 415 that provides means for further refining the recommendations provided in the gallery pane 410. The search criteria pane 415 may include a text field for receiving search terms for further refining the recommended templates and/or other options for further refining the search results. For example, the search criteria may include options for limiting the template recommendations to a particular type of template for a particular application, to limit the search to a particular discrete part of the organization associated with the user, a data range in which the templates were published, and/or other types of criteria that may be used to further refine the recommendations provided to the user.

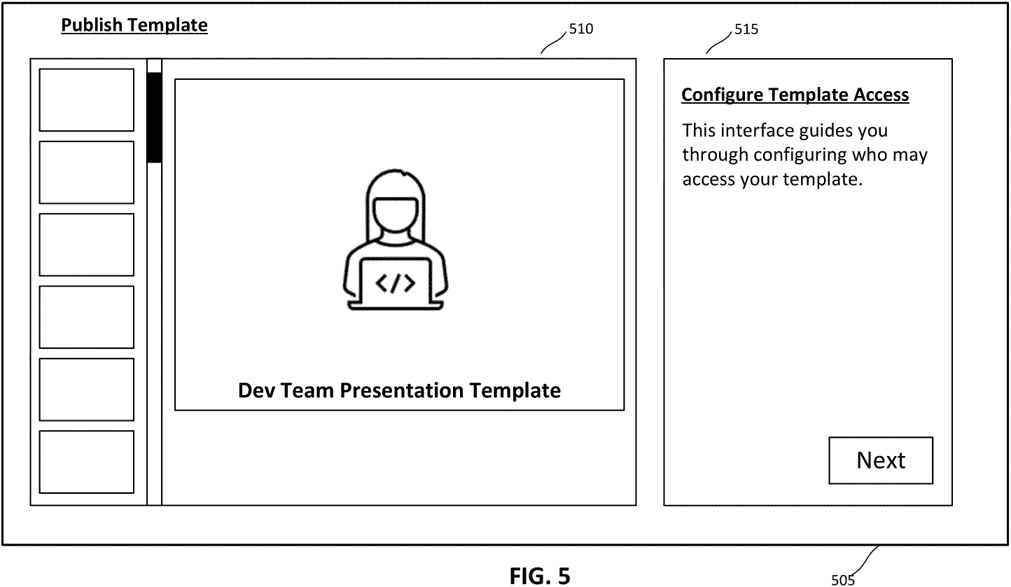

FIG. 5 is a diagram showing an example graphical user interface 505 for adding a new template to the template gallery shown in FIG. 4. The user interface 505 may be presented on a display of the user device 105 of a user. The user interface may select an existing template, which is shown in the template pane 510. The template may have been created using template creation functionality provided by the template publication service 110 or by the application service 125. The template may also have been created by the user using tools available to the user on the client device 105 of the user. The user interface 505 may provide tools for selecting the template from a location stored on the client device

The user interface 505 includes a configure template access pane 515. The configure template access pane 515 may guide the user through setting up the policy associated with the template. The policy information may be used to configure who may access the template and/or perform other actions associated with the template.

FIG. 9 is an example of a template usage report user interface 905 that may be provided by the template publication service 110. The template usage report user interface 905 may be presented by the template publication service 110. The template usage report contents shown in the user interface 905 may be generated by the template savings unit 225 of the template publication service 110. The template usage report shown in FIG. 9 includes an estimate of how much time that users may have been saved by using each template shown in the report and an estimated monetary savings that may have been achieved based on the estimated time savings. The template savings unit 225 may be configured to automatically generate the template usage report according to a specified interval. The interval may be configurable by users of the system. The user may also specify who should receive the report. For example, a manager of a particular organization may wish to receive the template usage report on a monthly basis and a message indicating that the report is available may be sent to a group of managers within the organization. The template savings unit 225 may generate the report on a monthly basis and send a link to the specified users. The recipients of the message may click on or otherwise activate a link the report that causes the link to be displayed in a native application or a browser application installed on the respective client device 105 of the users.

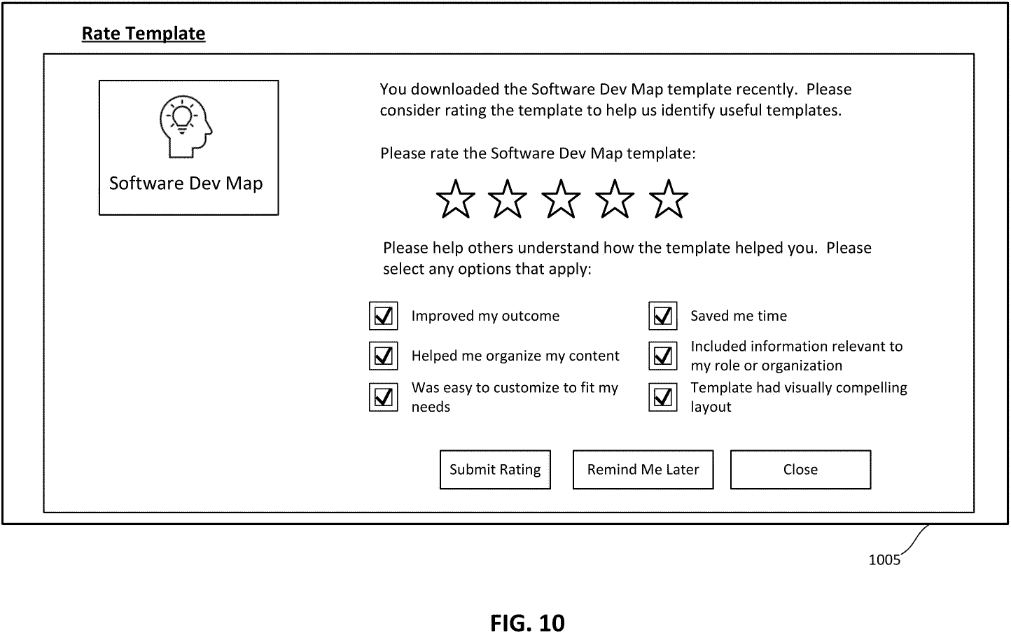

FIG. 10 is an example of a template rating user interface 1005 that may be provided by the template publication service 110. The template rating user interface 1005 may be presented to a user that has accessed a template using the template publication service 110. The template feedback unit 230 of the template publication service 110 may be configured to prompt the user to provide feedback on templates that the user has accessed. The template feedback unit 230 may be configured to display the user interface 1005 to the user while the user is accessing the services provided by the template publication service 110 via the browser application 255 and/or the native application(s) 250 of the client device 105. The template feedback unit 230 may cause the rating user interface 1005 to be displayed to the user automatically. The user may provide a rating, request that they be prompted again for a rating at a later time, or request that the user interface 1005 be closed. While the example shown in FIG. 10 includes a star-based rating system, other implementations may include other means for rating the template. Other implementations may also include a text field that permits the user to add a comment with the rating they have provided. The comments may be presented to users with the rating information and/or to the creator of the template.

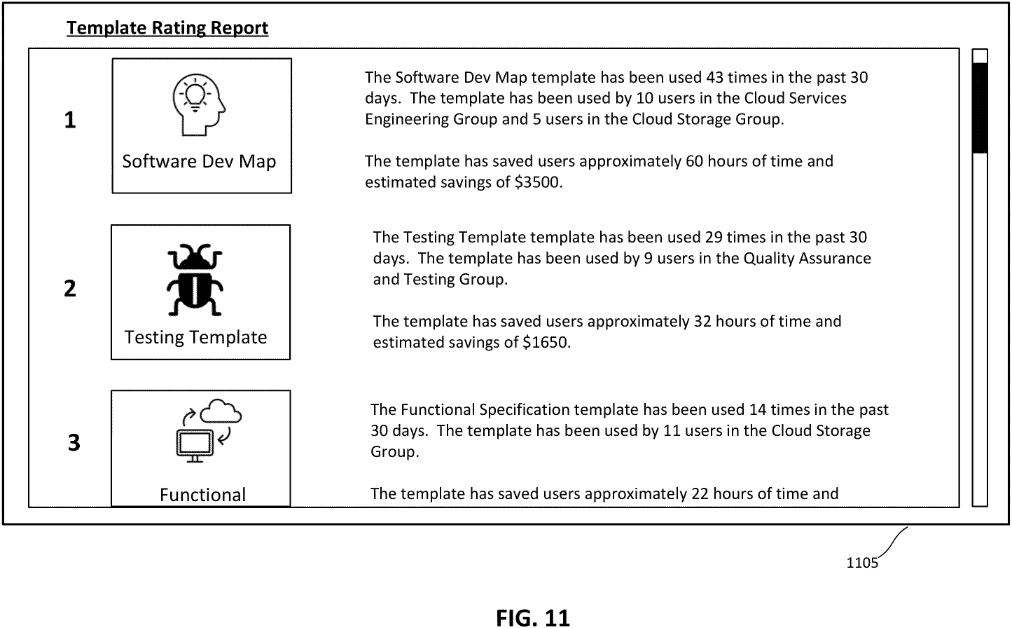

The template feedback unit 230 may aggregate the rating information received from multiple users to generate aggregate rating information for a template. The template may be ranked, at least in part, based on this aggregate ranking information. The ranked templates may be shown in the templating rating report shown in FIG. 11.

FIG. 11 is an example of a template rating report user interface 1105 that may be provided by the template publication service 110. The template rating report may show templates that have saved users the most time and/or an organization the most money. The template rating report may also include a rating based on user input received from users of the templates. The template rating report may be configurable to provide a user with template ratings for templates associated with a particular organization. These templates may have been used and/or created by users within the organization. This approach may allow an administrator at that organization to identify templates that have saved significant amounts of time and/or money for users within that organization and to encourage the creation of other such templates that may provide additional savings to the organization.

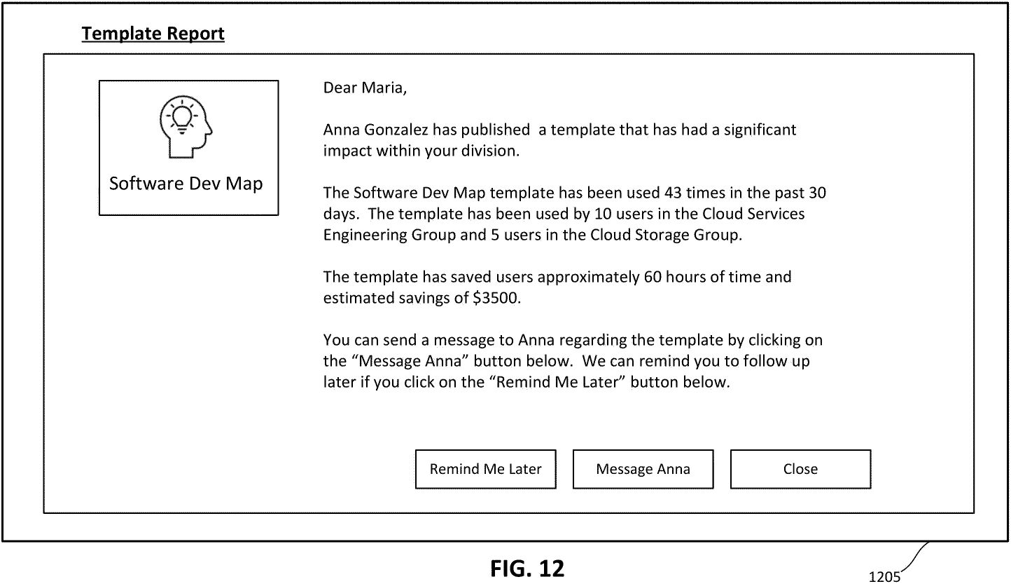

FIG. 12 is an example of a template report user interface 1205 that may be provided by the template publication service 110. The template report may provide information to a manager of an organization or a division thereof. The template report may include information that identifies an employee that has created a template, rating information associated with the template, and information indicating a business impact provided by users within the organization using the template. The user interface 1205 may include a control, which when clicked or otherwise activated, enables the administrator or manager receiving the report to contact the user who created the template. The user interface 1205 may also included a control, which when activated, provides a reminder to the administrator or manager to follow up with the user who created the template. The report may be used to provide an incentive for employees to create templates by highlighting the impact that such templates may have on the organization.

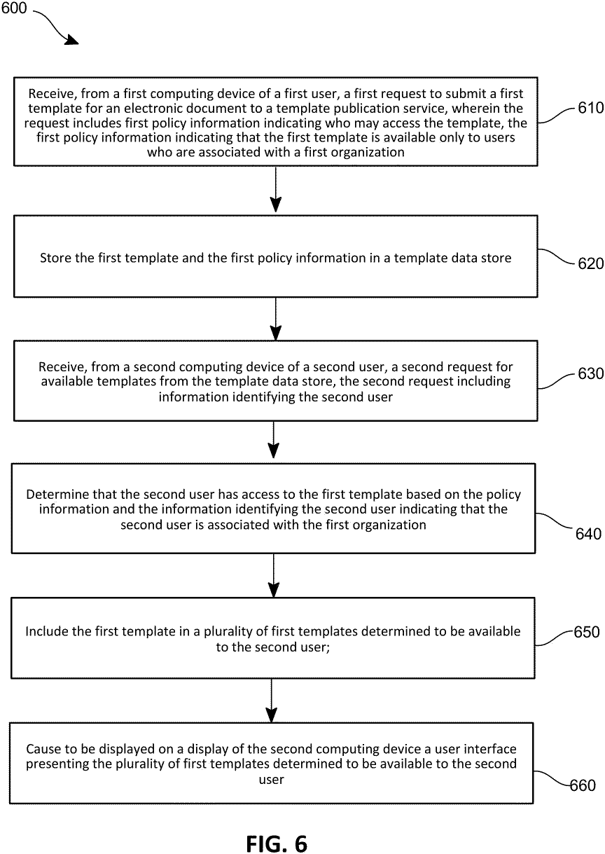

FIG. 6 is a flow chart of an example process 600 for publishing a template for an electronic document. The process 600 may be implemented by the template publication service 110 shown in the preceding examples.

The process 600 may include an operation 610 of receiving, from a first computing device of a first user, a first request to submit a first template for an electronic document to a template publication service, wherein the request includes first policy information indicating who may access the template, the first policy information indicating that the first template is available only to users who are associated with a first organization. A first user may create a template and publish that template to the template publication service 110. As discussed in the preceding examples, the first user may provide policy information that specifies who may access the policy once the policy has been published by the template publication service 110. In this example implementation, the first user indicates in the policy information that the first template may only be accessed by other users who are associated with the first user. Limiting the access of the template to users associated with a particular organization may have a couple of important benefits. First, this approach prevents the unauthorized dissemination of potentially sensitive information to users who are outside of the organization. Second, this approach helps to promote template reuse within an organization by allowing users to search for templates that were created by other users within the organization, which are more likely to be useful to other users within the organization. Other such template providers may provide a vast number of templates that are irrelevant to most users and users waste a significant amount of time and computing resources browsing through the available templates to try to find a template that suits their needs.

The process 600 may include an operation 620 of storing the first template and the first policy information in a template data store. The template publication service 110 may store the first template in a template date store. In some implementations, the template data store may store all of the published templates in a single data store and control who may access the templates based on the policy associated with each of the templates. In other implementations, the template publication service 110 may include a dedicated data store for templates associated with a particular organization. The template publication service 110 may determine that the template belongs in the dedicated data store for a particular organization based on the policy information provided with the request to publish the template. In some implementations, the template publication service 110 may be automatically configured to apply a policy to templates from the organization that indicates that the templates may not be disseminated outside of the organization.

The process 600 may include an operation 630 of receiving, from a second computing device of a second user, a second request for available templates from the template data store, the second request including information identifying the second user. Another user may send a request for available templates to the template publication service 110. In this example, the second user is associated with the same organization as the first user.

The process 600 may include an operation 640 of determining that the second user has access to the first template based on the policy information and the information identifying the second user indicating that the second user is associated with the first organization. As discussed in the preceding examples, the template publication service 110 may be used to control who may view, access, create, and/or modify templates for the template publication service 110 and may publish a template to a scoped part of an organization. The template publication service 110 may determine that the second user is authorized to access the first template based on the policy information associated with the first template, which indicates that the first template may only be accessed by users associated with the first organization. The user information provided with the request indicates that the user is associated with the same organization as the first user. Therefore, the first template may be presented to the second user in response to the request for available templates. Other templates that have no access control policy or for which the policy indicates that the second user may access the template may also be presented to the second user.

The process 600 may include an operation 650 of including the first template in a plurality of first templates determined to be available to the second user. The template recommendation unit 220 of the template publication service 110 may include templates for which the policy information associated with the templates indicates that the second user may access the template.

The process 600 may include an operation 660 of causing to be displayed on a display of the second computing device a user interface presenting the plurality of first templates determined to be available to the second user. An example of such an interface is shown in FIG. 4.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

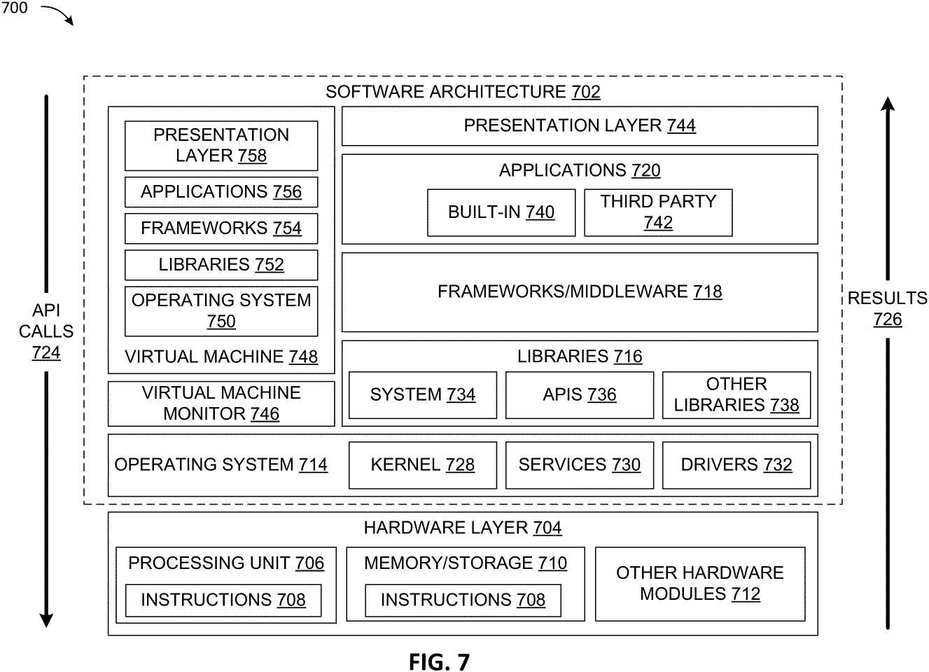

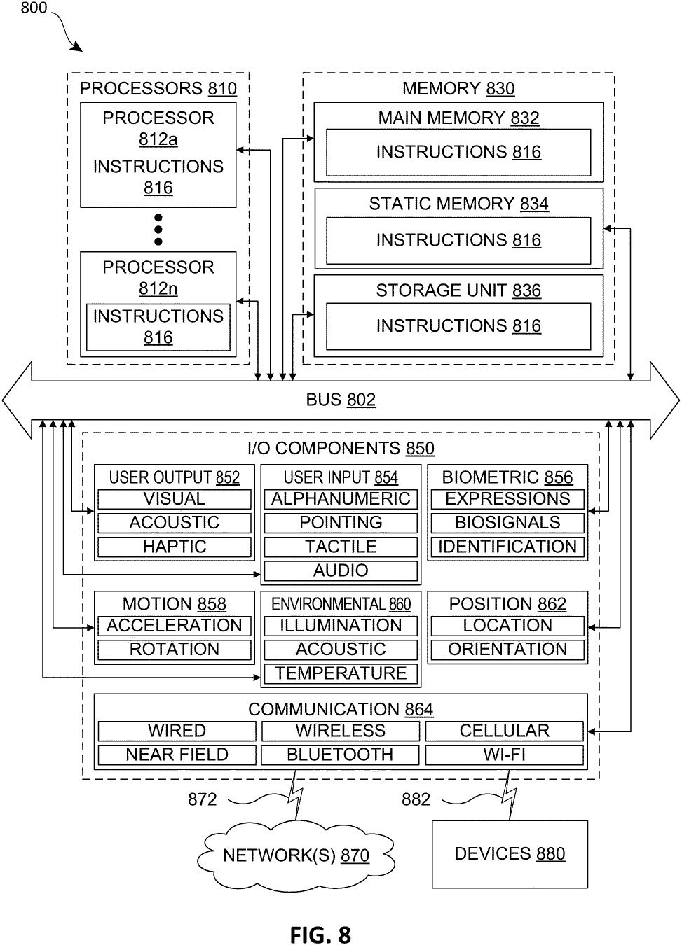

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 1436 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 862, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable medium storing executable instructions that, when executed, cause the processor to perform operations comprising:
receiving, from a first computing device associated with a first user, a first request to submit a first template for an electronic document to a template publication service, wherein the request includes first policy information indicating who may access the template, the first policy information indicating that the first template is available only to users who are associated with a first organization;
storing the first template and the first policy information in a template data store;
receiving, from a second computing device associated with a second user, a second request for available templates from the template data store, the second request including information identifying the second user;
determining that the second user has access to the first template based on the policy information and the information identifying the second user indicating that the second user is associated with the first organization;
including the first template in a plurality of first templates determined to be available to the second user; and
causing to be displayed on a display of the second computing device a user interface presenting the plurality of first templates determined to be available to the second user.

2. The data processing system of claim 1, the machine-readable medium including instructions configured to cause the processor to perform operations comprising:
receiving, from a third computing device of a third user, a third request for available templates from the template data store, the third request including information identifying the third user;
determining that the third user does not have access to the first template based on the policy information and the information identifying the third user indicating that the third user is not associated with the first organization;
excluding the first template in a plurality of second templates determined to be available to the third user;
causing to be displayed on a display of the third computing device a user interface presenting the plurality of second templates determined to be available to the third user.

3. The data processing system of claim 1, the machine-readable medium including instructions configured to cause the processor to perform operations comprising:
determining a recommended subset of the templates available to the second user by analyzing the information identifying the second user and policy information associated with the available templates using one or more machine learning models;
receiving a prediction from each of the one or more machine learning models comprising a recommended subset of the templates available to the second user; and
causing at least a portion of the recommended subset of the templates available to the user to be presented on the display of the second computing device associated with the second user.

4. The data processing system of claim 3, wherein the one or more machine learning models includes a machine learning model configured to predict attributes of templates in which the second user may be interested based on template usage history of the second user.

5. The data processing system of claim 3, wherein the one or more machine learning models includes a machine learning model configured to predict attributes of templates in which the second user may be interested based on a role within the first organization of the second user.

6. The data processing system of claim 1, the machine-readable medium including instructions configured to cause the processor to perform operations comprising:
automatically determining an estimated cost savings provided to the first organization by the first template by estimating an amount of time saved by users using the first template and a monetary cost associated with the amount of time saved; and
automatically generating a cost savings report including the estimated costs savings provided by the first template; and
sending the cost savings report to the computing device of a third user.

7. The data processing system of claim 1, the machine-readable medium including instructions configured to cause the processor to perform operations comprising:
receiving first rating information associated with the first template from the second computing device of the second user;
aggregating the first rating information with previously received rating information for the first template to generate aggregate rating information; and
ranking the first template according to the aggregate rating information.

8. A method implemented in a data processing system for operating a template publication service, the method comprising:
receiving, from a first computing device of a first user, a first request to submit a first template for an electronic document to the template publication service, wherein the request includes first policy information indicating who may access the template, the first policy information indicating that the first template is available only to users who are associated with a first organization;
storing the first template and the first policy information in a template data store;
receiving, from a second computing device of a second user, a second request for available templates from the template data store, the second request including information identifying the second user;
determining that the second user has access to the first template based on the policy information and the information identifying the second user indicating that the second user is associated with the first organization;
including the first template in a plurality of first templates determined to be available to the second user; and
causing to be displayed on a display of the second computing device a user interface presenting the plurality of first templates determined to be available to the second user.

9. The method of claim 8, further comprising:
receiving, from a third computing device of a third user, a third request for available templates from the template data store, the third request including information identifying the third user;
determining that the third user does not have access to the first template based on the policy information and the information identifying the third user indicating that the third user is not associated with the first organization;
excluding the first template in a plurality of second templates determined to be available to the third user;
causing to be displayed on a display of the third computing device a user interface presenting the plurality of second templates determined to be available to the third user.

10. The method of claim 8, further comprising:
determining a recommended subset of the templates available to the second user by analyzing the information identifying the second user and policy information associated with the available templates using one or more machine learning models;
receiving a prediction from each of the one or more machine learning models comprising a recommended subset of the templates available to the second user; and
causing at least a portion of the recommended subset of the templates available to the user to be presented on the display of the second computing device associated with the second user.

11. The method of claim 10, wherein the one or more machine learning models includes a machine learning model configured to predict attributes of templates in which the second user may be interested based on template usage history of the second user.

12. The method of claim 10, wherein the one or more machine learning models includes a machine learning model configured to predict attributes of templates in which the second user may be interested based on a role within the first organization of the second user.

13. The method of claim 8, further comprising:
automatically determining an estimated cost savings provided to the first organization by the first template by estimating an amount of time saved by users using the first template and a monetary cost associated with the amount of time saved; and
automatically generating a cost savings report including the estimated costs savings provided by the first template; and
sending the cost savings report to the computing device of a third user.

14. The method of claim 8, further comprising:
receiving first rating information associated with the first template from the second computing device of the second user;
aggregating the first rating information with previously received rating information for the first template to generate aggregate rating information; and
ranking the first template according to the aggregate rating information.

15. A machine-readable storage medium on which are stored instructions that, when executed, cause a processor of a programmable device to perform functions of:
receiving, from a first computing device of a first user, a first request to submit a first template for an electronic document to a template publication service, wherein the request includes first policy information indicating who may access the template, the first policy information indicating that the first template is available only to users who are associated with a first organization;
storing the first template and the first policy information in a template data store;
receiving, from a second computing device of a second user, a second request for available templates from the template data store, the second request including information identifying the second user;
determining that the second user has access to the first template based on the policy information and the information identifying the second user indicating that the second user is associated with the first organization;
including the first template in a plurality of first templates determined to be available to the second user; and
causing to be displayed on a display of the second computing device a user interface presenting the plurality of first templates determined to be available to the second user.

16. The machine-readable storage medium of claim 15, further comprising instructions configured to cause the processor to perform operations comprising:
receiving, from a third computing device of a third user, a third request for available templates from the template data store, the third request including information identifying the third user;
determining that the third user does not have access to the first template based on the policy information and the information identifying the third user indicating that the third user is not associated with the first organization;
excluding the first template in a plurality of second templates determined to be available to the third user;
causing to be displayed on a display of the third computing device a user interface presenting the plurality of second templates determined to be available to the third user.

17. The machine-readable storage medium of claim 15, further comprising instructions configured to cause the processor to perform operations comprising:
determining a recommended subset of the templates available to the second user by analyzing the information identifying the second user and policy information associated with the available templates using one or more machine learning models;
receiving a prediction from each of the one or more machine learning models comprising a recommended subset of the templates available to the second user; and
causing at least a portion of the recommended subset of the templates available to the user to be presented on the display of the second computing device associated with the second user.

18. The machine-readable storage medium of claim 17, wherein the one or more machine learning models includes a machine learning model configured to predict attributes of templates in which the second user may be interested based on template usage history of the second user.

19. The machine-readable storage medium of claim 15, further comprising instructions configured to cause the processor to perform operations comprising:
automatically determining an estimated cost savings provided to the first organization by the first template by estimating an amount of time saved by users using the first template and a monetary cost associated with the amount of time saved; and
automatically generating a cost savings report including the estimated costs savings provided by the first template; and
sending the cost savings report to the computing device of a third user.

20. The machine-readable storage medium of claim 15, further comprising instructions configured to cause the processor to perform operations comprising:
receiving first rating information associated with the first template from the second computing device of the second user;
aggregating the first rating information with previously received rating information for the first template to generate aggregate rating information; and
ranking the first template according to the aggregate rating information.
